(19) United States
(12) Patent Application Publication
(10) Pub. No.: US 2012/0087537 A1
(43) Pub. Date: Apr. 12, 2012

(54) SYSTEM AND METHODS FOR READING AND MANAGING BUSINESS CARD INFORMATION

(76) Inventors: Lisong Liu, Fremont, CA (US); Lai Chen, Fremont, CA (US)

(21) Appl. No.: 12/903,007

(22) Filed: Oct. 12, 2010

(51) Int. Cl. G06K 9/00

(52) U.S. Cl. 382/100; 382/182; 382/321

(57) ABSTRACT

A system and method for business card information reading and managing comprises a scanner which is optional and can provide dark background, a preprocessing module, a host computer with data storage, input/output (I/O), and display devices, an information extracting module, optical character recognition (OCR) engine, an image-processing (IP) engine, an information organizing module, all connected to the host computer to work together. On top of the system is the dataflow logic, i.e. the method, which guides all the business card information reading and management in a sequence of steps. The method is supported mainly through the software (SW) running on the host computer, with a GUI to interact with end users and provides functions like scanning/loading images and managing result. Among the steps, there are automatic card boundary and orientation detection step/method, manual card boundary and orientation refining step/method, automatic key information area detection step/method, manual key information area refining step/method by using a set of template key information items as over-layers on the GUI's image display. There is also key information extraction step which uses optical character recognition (OCR) and image processing to extract key information from cards and put the results in a table which can be further edited, merged with another table, and/or saved.

### CROSS-REFERENCE TO RELATED PATENT APPLICATION

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference. In terms of notation, hereinafter, “[n]” represents the nth reference cited in the reference list. For example, [4] represents the 4th reference cited in the reference list, namely, J. Flusse et al, “Affine Moment Invariants: A New Tool for Character Recognition,” Pattern Recognition Letters, Vol. 15, pp. 433-436, 1994.

### FIELD OF THE INVENTION

This invention generally relates to a system and a method for business card information reading and management.

### BACKGROUND OF THE INVENTION

All existing business card readers are standalone electronic devices (U.S. Pat. Nos. D367473, 5,493,105, 5,604,640, 6,681,991, 6,783,060, 6,796,500, 6,799,719), and some of them are portable. In general, they are dedicated for business card reading and convenient to carry. But their disadvantages are also obvious. For example: 1) they can only scan and process single card or very limited business cards at a time; 2) when a card quality is poor and therefore the scanned image is in poor quality, they cannot not allow a user to enhance the image quality or to interactively assist the detection of the information on the business card; 3) when scan results are obtained they do not allow the user to manage the results easily, e.g. for result searching, editing, merging, retrieving results which partly because they are small devices and do not have powerful data input and output mechanisms as a regular computer do, 4) a dedicated device cannot be used for any other application which actually is a kind of waste of resources, 5) a dedicated device cannot make use of any general purpose software which can be powerful and always stays up to date with the newest technologies in computer hardware (HW) and software (SW), e.g. powerful computer processors and new programming languages and tools, and cannot make use of powerful networking including wireless networking features of a modern computer has. As a result, up to date, there is no effective, efficient, and user-friendly business card reading and managing system/tool widely accepted and used, and most people still have to organize their business cards manually.

Therefore, a heretofore unaddressed need exists in the art to address the aforementioned deficiencies and inadequacies.

### SUMMARY OF THE INVENTION

In one aspect, the present invention relates to a system and a method for reading and managing business card information. In one embodiment of the invention, the system architecture as shown in FIG. 1 includes a scanner, a host computer (used as the main processing power with its data input and output mechanism such as display screen, keyboard, and mouse), a preprocessing module for preprocessing cards such as detecting and refining card boundaries and orientation in the image, doing image processing on cards, and detecting and refining key information areas in each card, an information extracting module for extracting key information items such as prefix, name, suffix, email address, phone number, mobile phone number, fax number, address, web site address etc. from key information areas, an optical character recognition (OCR) engine used by information extracting module, an image processing (IP) engine used by OCR engine and a preprocessing module for various image processing tasks, an information organizing module for resulting business card information management, and a database system used by information organizing module and by the software on the computer as well. Also on the computer, there runs the main software for all business card information reading and result display and management applications, with its graphical user interface (GUI), data structures, SW architecture, and algorithms governing the complete lifecycle of business card reading and managing. It also contains networking including wireless networking power. Therefore, by using the invented method and system step by step, as shown in the dataflow diagram in FIG. 2, the user can extract information of one or more business cards simultaneously and manage the extracted information properly for various business and personal purposes.

The host computer is connected to all the other components of the system as shown in FIG. 1. Different from other business card readers, the system is flexible so that the scanner can be a build-in module on the system or an off-shelf general-purpose product connected to the computer, or there can be no scanner connected to the computer of the system, and in this case the images containing business cards scanned by other scanners can be loaded from a computer data storage media e.g. a hard disk. The connection between the scanner and the host computer is also flexible, which can use Ethernet cable using Transmission Control Protocol/Internet Protocol (TCP/IP) protocol or universal serial bus (USB) cable using USB protocol. There is no limitation to the format of a scanned image, whether compressed or uncompressed, in BMP, TIFF, or in other format. Other components, such as the preprocessor/processing module, the information extractor/information extracting module, the optical character recognition (OCR) engine, and the image processing (IP) engine can be hardware devices such as application-specific integrated circuit (ASIC) chips, firmware on hardware devices such as Digital Signal Processor (DSP) or field-programmable gate array (FPGA), or as pure software modules on the host computer. The information organizer/information organizing module and the database system are also on the host computer. Also, there is no limitation to the operating system (OS) on the computer.

There is a main GUI on the host computer as the entry point and center coordinator for all applications of the business card information reading and managing system. It mainly contains a menu bar area and an image display area. In addition to typical window functions such as “Help” and “Exit”, there are other application-specific functions on its menu bar as “File”, “Preprocess”, “Enhance”, “Extract”, and “Tools” etc. The “File” menu item contains sub menu items for the user to scan or open from computer data storage media, one image or a pair of images, as well as to close or to save the image(s). The “Preprocess” menu item contains sub menu items for the user to preprocess cards in an image, e.g. to find and adjust their boundaries, their orientation and to rotate the image to correct their orientations, to relocate them, to add or delete a card, to detect key information area both automatically and manually, and to enable or disable a key information area. The “Enhance” menu item contains sub menu items for the user to enhance image quality of selected cards (by computer mouse) via image processing functions such as noise filtering, brightness and contrast change i.e. histogram manipulation, as well as allowing the user to erase unwanted pixels in a card image in a scanned image in image display window. The “Extract” menu item allows the user to extract card information and put it into a temporary table. The “Tools” menu item allows the user to configure what key information items to appear and to be extracted from the cards. The “Help” menu bar item provides the user guide documents and tells about the SW release version. Some of the menu bar items support quick/shortcut keyboard access keys when a character in the menu bar has an underscore as a convention in computer world, e.g. “E” is the quick access keyboard key for menu bar item “Extractor”.

With the functions from the main GUI, the user can follow up steps in the dataflow diagram in FIG. 2 to extract business card information, put it into a temporary table for further editing, merging, and save the information in the table to the data storage media of the host computer.

In one embodiment of the invention, one image, whether scanned or loaded from the computer's data storage media, can contain one or more business cards, partly due to the flexible system design in the invention. The card boundaries can be automatically detected by image processing algorithms in this invention e.g. by projecting the image in horizontal and vertical directions, detecting their plateaus in both projections, back projecting the plateau boundaries into image space, and using total counts to qualify candidate cards in image. Since automatic card finding method may not work all the time, it also allows the user to further manually modifying card boundaries, and add/delete cards to/from the image display area, and to give/change card's ID (every detected business card in image display area shall have a unique ID. Furthermore, to enhance the automatic card detection capability, the scanner if it is an integrated part of the system, can be made to always provide dark background to help better detecting the card areas in the image. After finding cards in the image, it also does automatic card orientation detection and correction. Which can be done for example, by rotating the card in both directions in a set of small angles, then projecting the original image and the rotated image in horizontal/X direction or vertical/Y direction, finding the projection peak/maximum value at each angle of rotation, and doing a curve fitting to find the angle corresponding to the highest peak in the fitted curve. Since automatic angle detection does not always work perfectly and it is time consuming, so the invention also allows the user to manually change the card orientation by rotating it around an axis which normally goes through the center of a card on the image. All cards in an image will be given a unique identification (ID), and the user can modify that too. To allow reading information from both sides of a card, the software (SW) designed for the invention allows the user to load a second image, i.e. to have one card in two images as front side and backside will have the same ID and the backside one will be further marked by an appendix, so that when their information is extracted, they can be put in one row for one card in the table which holds all card information extracted. When there are two pieces of conflicting information from two sides of a card, the one from the front side take the higher priority. For better detection and better keeping a card's information, it allows the user to do some image processing on selected cards (by computer mouse) like noise filtering, histogram manipulation like brightness/contrast changing etc., and it allows the user to erase some of the unwanted pixels from the card image, and allows the user to save the each card's image.

When each business card's boundary and orientation in the scanned image(s) have been detected and fixed, the software (SW) designed for this invention will first try to automatically identify key information areas, e.g. areas which contain prefix, name (first name, middle name or initial, last name), suffix, email address, phone number, mobile phone number, fax number, affiliation, address, web site URL, and even logo. The automatic key information detection can be done by searching key characters or character combinations such as “www”, “.com”, “.edu”, “.org”, and “@” sign using some OCR techniques. This automatic detection may not be perfect, so the SW in the invention provides for each business card a set of templates for all the selected key information items and their corresponding key information areas as rectangles/bounding box (over-layer drawings with a line connected between the bounding box and the name as text over-layer also), so that the user will only need to modify i.e. to resize, move, enable, disable the bounding boxes of the key information areas. Then it extracts information form all key information areas from all cards on the image(s) and put them into a temporary table, and allows the user to further modify the contents in the table. Finally it allows the user to merge the contents in the temporary table to another table whether it is in a saved file on the computer storage media or an opened table, and it allows the user to save the table. The saved business card information can be put into a database on the computer, or simply in a file system using Microsoft Office Excel™ spread sheets or in Extensible Makeup Language (XML) format. It allows the user to retrieve needed information from an existing table or to edit the table, and to print out the information in various ways. Further it allows the user to print our contents of a table in many different ways and even exporting them to a network (including wireless network) device.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

FIG. 1 shows a system architecture according to one embodiment of the invention, as the platform for applying the invention.

FIG. 2 shows a dataflow diagram according to one embodiment of the invention, with detailed steps in sequence for applying the invented methods for business card information reading and management.

FIG. 3 shows a graphical user interface (GUI) of the software which provides the user a way to use the invention interactively.

FIG. 4 shows the main graphical user interface (GUI), with menu bar functions and image display area to display business card image(s).

FIG. 5 shows the image display area displaying the second image, which is typically for the backsides of some business cards in image one, according to one embodiment of the invention. It also shows an example of a skew angle between a card and the image.

FIG. 6 shows a dataflow diagram, also a logic flow diagram of an automatic card boundary finding algorithm according to one embodiment of the invention.

FIG. 7 shows the image display area displaying a business card image scanned with dark background which is more suitable for automatic card boundary detection and orientation detection, according to one embodiment of the invention.

FIG. 8 shows a dataflow diagram/logic flow diagram for finding business card angle/orientation in a scanned image, according to one embodiment of the invention.

FIG. 9 shows an example, as the result of automatic card boundary detection in the invention.

FIG. 10 shows an example, as the result of automatic and manual card boundary finding, automatic and manual card orientation finding and correction.

FIG. 11 shows an eraser on the GUI for the user to wipe out unwanted pixels from a business card image, according to one embodiment of the invention.

FIG. 12 shows selected business cards in the image display window with template key information areas as over-layer rectangles with corresponding names on some of the cards, according to one embodiment of the invention.

FIG. 13 shows all template key information areas as rectangles on business card image, each with a connecting line connecting to their corresponding names.

FIG. 14 shows a table for holding the key information extracted from the business cards in the image, with its columns for configured key information items, and each row to hold information of a card, according to one embodiment of the invention.

FIG. 15 shows the menu bar functions and some of their sub menu buttons of the table for holding the extracted key information.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

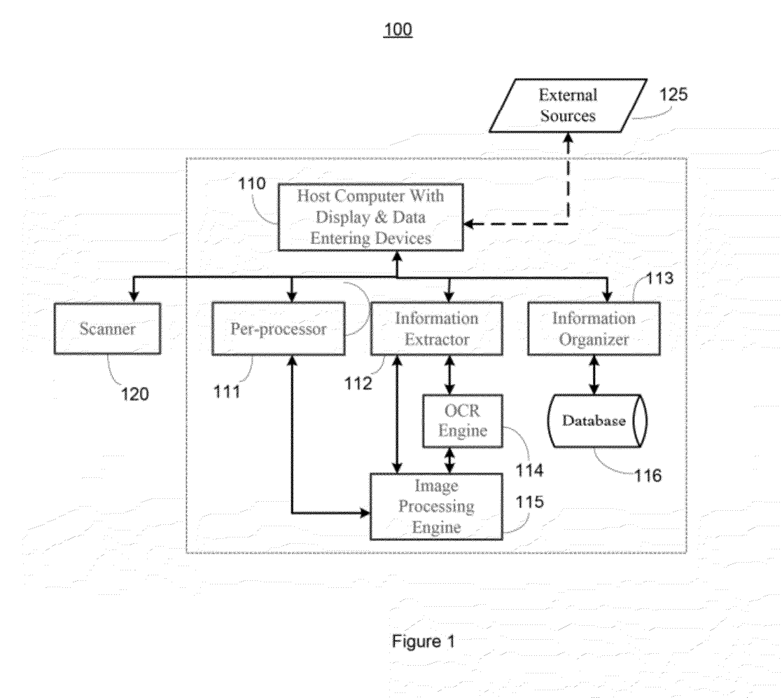

The description will be made as to the embodiments of the present invention in conjunction with the accompanying drawings in FIGS. 1-15. In accordance with the purposes of this invention, as embodied and broadly described herein, this invention, in one aspect, relates to a systems and methods for reading and managing business card information for business and personal purposes.

### The System

The invented system 100 as in one exemplary embodiment shown in FIG. 1 includes a host computer 110 as the main processing center with its display (not shown) and data entering mechanism such as keyboard (not shown) and mouse (not shown), a business card preprocessor/preprocessing module 111, a business card information extractor/information extracting module 112, an optical character recognition (OCR) engine 114, an image processing (IP) engine 115, an business card information organizer module 113, an optional database 116, and a business card scanner 120.

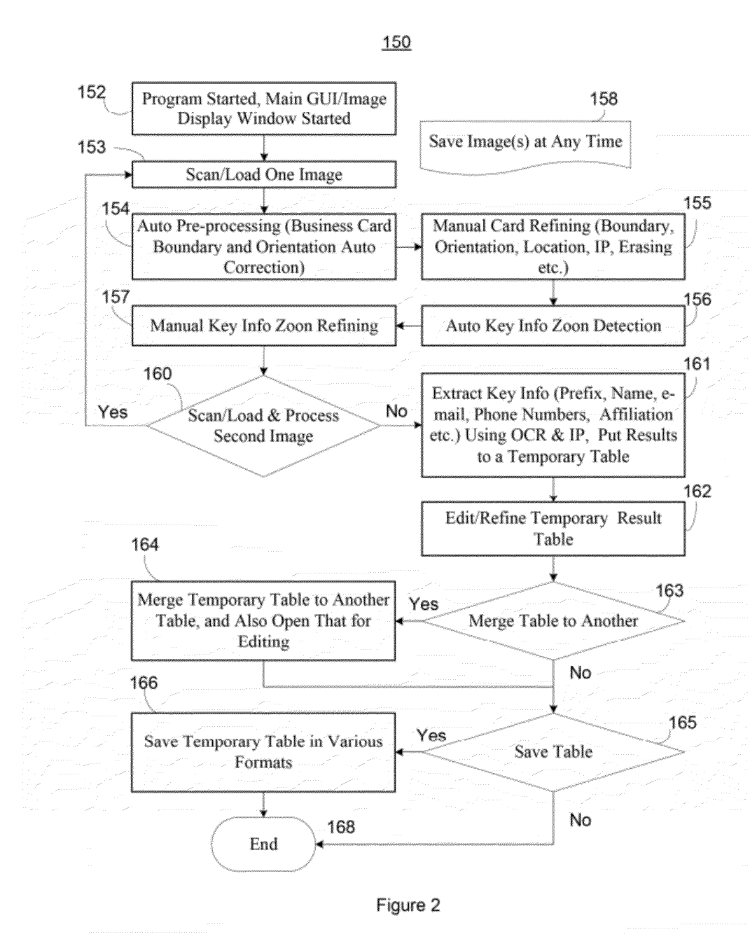

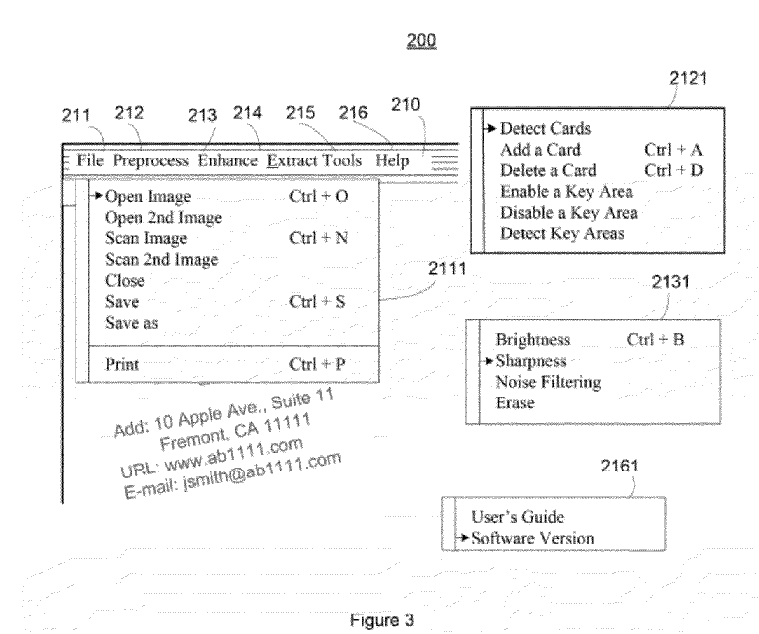

The host computer 110 is the center processing power with its data input device such as key board and mouse, and its output device such as display screen. It connects to all the other modules in the system 100, and it can also connect to some external data sources 125 and computers through networking including wireless networking. It can be a general purpose computer or a dedicated computer with no limit to its hardware (HW) architecture and operating system (OS). On the host computer, there runs the main software which provides GUI to end users to use the invention, and internally it has its complete SW architecture, data structure, algorithms, and on top of them the dataflow logic as shown in dataflow diagram 150 (FIG. 2) to support the complete lifecycle of business card information reading and management. The SW typically includes an entry graphical user interface (GUI), which can, but does not have to be an image display window 200 (FIG. 3) to display one scanned image with one or more cards, or a pair of scanned images, one image for the front side and one image for the backside of the same cards. The software (SW) shall also include result-holding and presentation components such as business card information table with its controls. The details of the entry GUI/image display window and the table for holding the results will be covered in details in later sections.

The preprocessing module 111 is responsible for preprocessing cards in a scanned image, and its functions include detecting and refining each card's boundary and orientation in scanned image, enhancing image quality by applying image processing algorithms such as noise filtering and histogram manipulation [1, 2], zooming/resizing of the whole image [1, 2], and then detecting and refining boundaries of key information areas in each card. These functions can be executed automatically and/or manually with the user interaction via the main SW.

The information extracting module 112 is responsible for extracting key information from each card in the scanned image. The key information shall include prefix, name (first name, middle name or initial, last name), suffix, e-mail address, phone number, fax number, mobile phone number, affiliation, address (of the affiliation), web address (of the affiliation) etc. During information extraction, the information extracting module 112 shall use OCR engine 114 and possibly image processing (IP) engine 115 as well.

The OCR engine 114 shall support at least English language, some other major western languages, and some major Asian languages such as Chinese without much limit to their fonts. It shall provide suitable OCR algorithms, e.g. region-based algorithms such as Hu's 7 moment invariants in reference [2, 3] and similar ones in references [4, 5], or boundary-based algorithms such as Fourier descriptor algorithm in references [2, 5, 6].

The image processing (IP) engine 115 shall support general IP functions as in references [1, 2], such as image noise filtering in spatial domain and in frequency/Fourier domain such as Butterworth filter and Gaussian filter or using median filter, edge detection using Sobel filter and Canny filter, histogram manipulation such as brightness and contrast modification, zooming/resizing of the whole image, transforms like Hough transform for line detection, morphological filters such as erosion, dilation, opening, and closing filter [1, 2].

The information organizer/information organizing module 113 is responsible for result data management. The data is the extracted key area information from each business card such as prefix, names, e-mail address, phone number, mobile phone number, fax number, affiliation, web address etc. They can be presented in table format and displayed on the host computer's display device, i.e., its monitor. The information organizer/information organizing module 113 normally is simply a SW module in the host computer 110. It can use a database system 116 for efficient data saving and retrieving, or can simply use host computer's file system to store the result data, and the data can be in simple text format, in Microsoft Office's Excel™ format, or in Extensible Makeup Language (XML) format.

The system design is flexible, that allows the scanner 120 to be an integrated part of the system 100 or a commercial general-purpose scanner connected to the host computer 110, e.g. through Universal Serial Bus (USB) cable using USB communication protocol or Ethernet cable using Transmission Control Protocol/Internet Protocol (TCP/IP) communication protocol. Furthermore there can be no scanner in the system and the business scanned images containing business cards are loaded from a data storage media in or connected to the host computer 110.

The system design is flexible, so that all the modules in the system as the preprocessing module 111, the information extracting module 112, the OCR engine 114, the IP engine 115, and the information organizing module 113, except the scanner 120 can be implemented in 1) pure HW; 2) firmware working on hardware e.g. Digital Signal Processor (DSP) device or Field-Programmable Gate Array (FPGA); or 3) pure SW on the host computer 110.

### The Method Working on the System

In one embodiment of the invention, the business card reading and managing SW runs on the host computer 110 to support all applications of the invention. When the SW starts, it brings up the main GUI to the user. The dataflow logic governing the use of the invented art is described in dataflow diagram 150 in FIG. 2, though variations from it with changes in steps, execution orders, and processes are still possible within the scope and spirit of this invention.

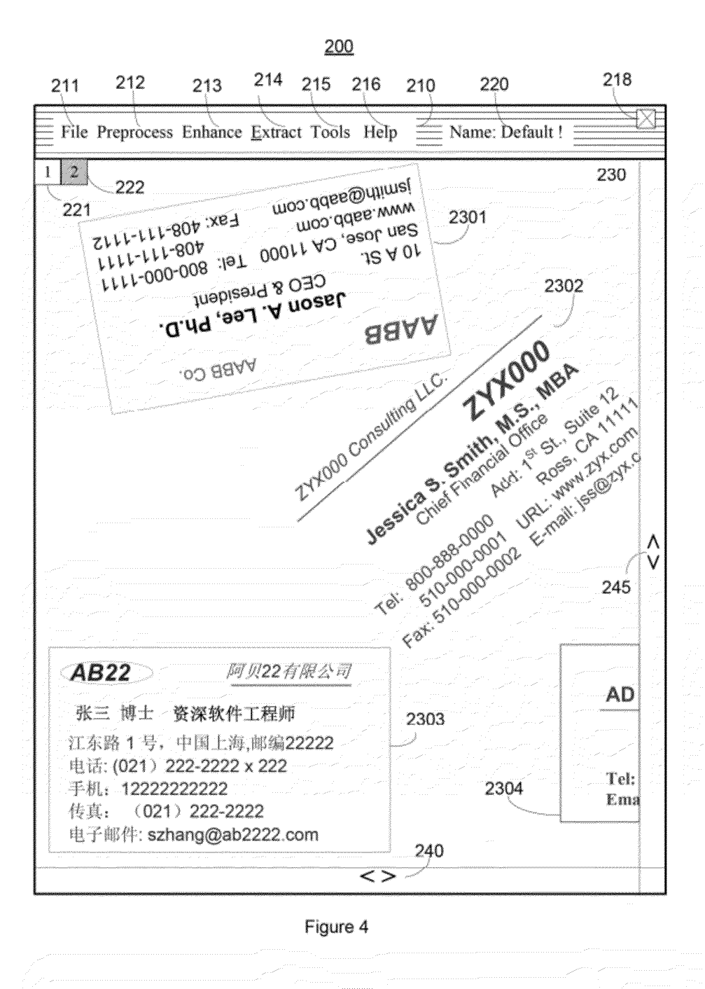

According to the dataflow diagram 150 shown in FIG. 2, as the first step 152, the application SW started by its user and running on the host computer 110, it brought up the main GUI which is essentially an image display window with image display area 230 and menu bar controls 200 as shown in FIG. 3. The main GUI's menu bar 210, as shown in FIG. 3 and FIG. 4, contains functional items as “File” 211, “Preprocess” 212, “Enhance” 213, “Extract” 214, “Tools” 215, and “Help” 216. It contains a name area 220 which will show a default name e.g. as “Default” when the name of the image in the image display area 230 has not been given by the user, and it will show a mark such as the exclamation sign “!” after the name when the content of the image display window has been changed and not yet been saved to the computer's storage media such as its hard disk. The user can change the name at any time. Similar to windows in other SW, it also contains a window closing button 218 on top-right corner. It contains a large image display area 230 under the menu bar, with a horizontal scroll bar 240 on the bottom and a vertical scroll bar 245 on the right side. On the top-left corner of the image display area, there are two buttons marked “1” 221 and “2” 222 for the user to switch/toggle the image display between two images, i.e. image 1 and image 2, one at a time. That feature is useful when information on both sides of some business cards need to be extracted, and the user can scan one side of business cards into one image and scan the other side of the same business cards into another image.

The “File” menu 211 further contains sub menu items 2111 as “Open Image” button for loading an existing image file from a storage media connected to the computer 110, “Open 2^{nd} Image” button for loading the second existing image file, typically the backside image of the cards in the first loaded image, “Scan Image” button for scanning an image of business cards from the scanner 120, “Scan 2^{nd} Image” button for scanning another image which are typically the backside of the business cards in the first image from the scanner 120, “Close” button for closing the image currently in the image display area, “Save” button for saving the current image or the pair of images to a storage media such as the hard disk of the computer 110, “Save as” button for saving the current image with a different name, and the “Print” button for printing the image(s) from a printer connected to the host computer 110. The saved image may not be the same as the initially scanned/loaded images due to possible preprocessing on card location, orientation, and image pixel values.

The “Preprocess” menu bar item 212 further contains sub menu bar items 2121 as “Detect Cards” button for automatically detecting boundary and location of each card in the image, “Add a Card” button for adding a card bounding box, a rectangular over-layer on the image of the selected card (by computer mouse) for the user to move it to a business card location on the image which has not been detected automatically by the SW, “Delete a Card” button for deleting a selected card by the user which normally is a falsely detected card by the SW/automatic detection algorithm in the SW, “Enable a Key Area” button for enabling a key information area and can further have pull-down menu buttons (not shown) for user to chose to add one of the key information areas for key information items as prefix, name (including first name, middle name, last name), title, e-mail address, phone number, mobile fax number, affiliation, address, web address/URL etc., “Enable a Key Area” button for enabling a key area which is null at the time, “Disable a Key Area” button for disable a selected key information area (by computer mouse), and “Detect Key Areas” button for automatically detect all key information areas within the boundary of a business card in the image or in the pair of images if there are two images, which may not yield perfect results and therefore needs the user's interaction to enable/disable key information areas by using “Enable a Key Area” and “Disable a Key Area” functions. Since all key information areas shown on all card in the image(s) are pre-determined templates, the user cannot add/delete them, but can enable/disable each of them, and can even configure the presence of them at a higher level for all cards in the image(s) (a function of “Tools” menu bar item, not shown).

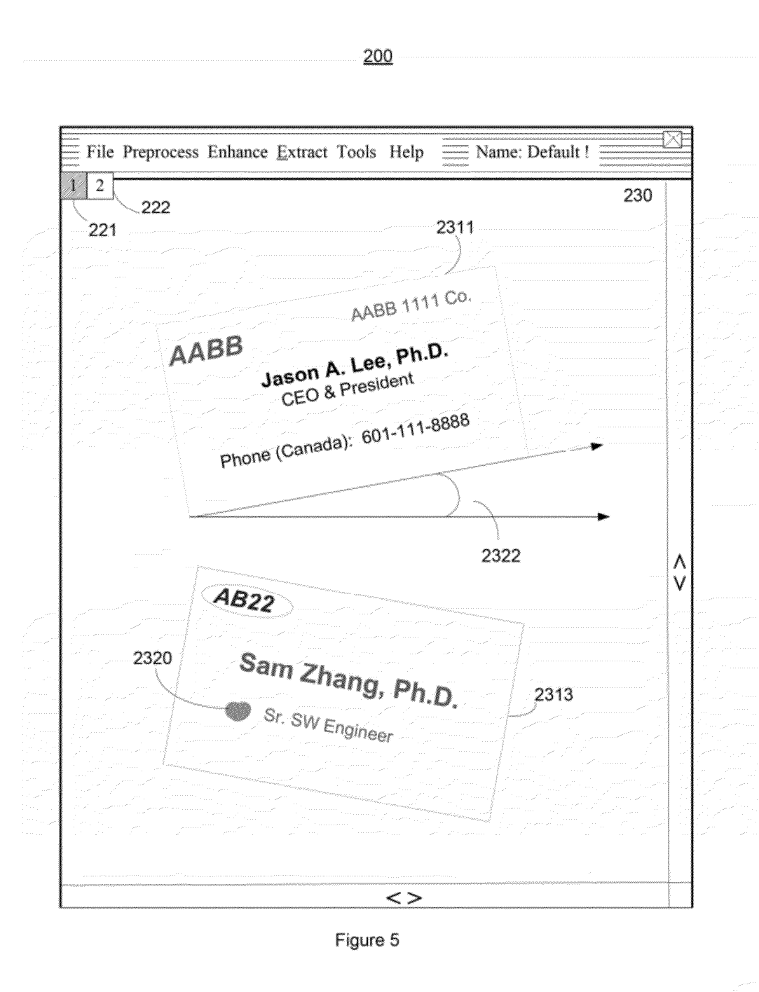

The “Enhance” menu item 213 further contains sub menu items 2131 for image enhancement as the “Brightness” button for the user to adjust image brightness from a popup window (not shown) for a selected card, the “Contrast” button for the user to adjust image contrast from a popup window (not shown) for a selected card, the “Noise filtering” for the user to choose different pre-defined noise filters such as median filter, Gaussian filter etc. to apply on the area within the boundary of a selected card, and the “Erase” button for bring up an eraser for the user to move it (using computer mouse motion) in the image display area to wipe out some foreground pixels, and it is helpful for removing some of the contaminated or unwanted areas 2330 on business cards in the image(s) (FIG. 5).

The “Extract” menu item 214 is for extracting key area information for all cards in the image or from the image pair and put the extracted information into a temporary table which will be explained in detail in later sections.

The “Tools” menu item 215 further contains sub menu items (not shown) for system and SW configuration. One of the features is to allow the user to select needed key information areas to appear for all cards in the image. It is because the SW provides a complete set of key area information for the user as templates, but the user can and normally shall configure the system to select only those key information items that he/she wants. For example, for some users, they are only interested in names and email addresses from the business cards.

The “Help” menu item 216 further contains sub menu items 2161 as “User's Guide” button for providing an electronic version of user's guide document, and the “SW Version” button for showing the release version of the current SW.

Then the next step according to dataflow diagram 150 is the step 153 to scan or load an image to the SW and display it in the image display area. Assuming here and hereafter, all images are black-white grayscale images. If not, color images will be converted to grayscale images first. One way to convert a color image into a grayscale image is to simply take the average of pixel values of R, G, and B bands of a color image before processing that scanned image. The user can either use the “Scan Image” button or the “Open Image” button as sub menu bar items 2111 of menu bar item “File” 211, to instruct the scanner 120 to scan an image of business cards or to load a previously scanned image of business cards from a data storage media, e.g. hard disk of the host computer 110. The image will be displayed in the image display area 230, and it normally contains plural numbers of business cards arranged approximately aligned i.e. with minor skew/rotation angle say smaller than 5° between the cards' horizontal/vertical boundaries and the horizontal/vertical boundary of the image containing the cards.

The non-perfect card orientation, e.g. 2322 in FIG. 5 is mainly because the cards are put on the scanner by the user manually, in some cases when the scanner 120 is not an integrated one of the system 100. FIG. 4 shows an example of some business cards 2301, 2302, 2302, 2303, and part of 2304 in the scanned image. Among them, card 2301 actually is almost upside-down as an unusual case. At this stage, the user can scan or load the second image which contains backsides of all or some of the business cards in the first image to the image display area in the main GUI, and the second image will be displayed when the user click the button “2” 222 (FIG. 5). As an example, FIG. 5 shows two business cards 2311 and 2313 as the backsides of cards 2301 and 2303 respectively in the first image shown in FIG. 4.

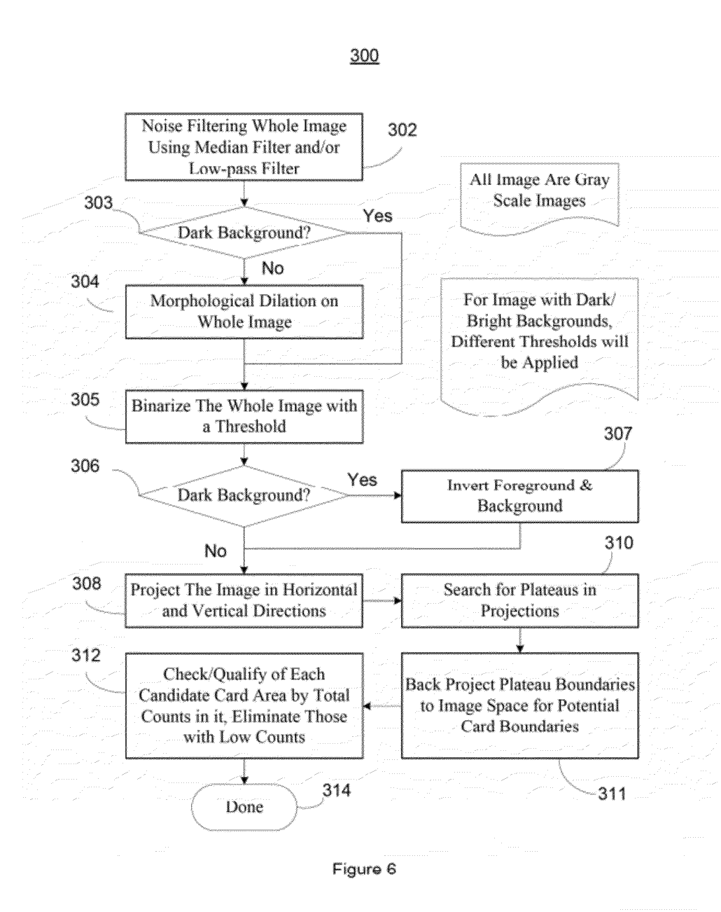

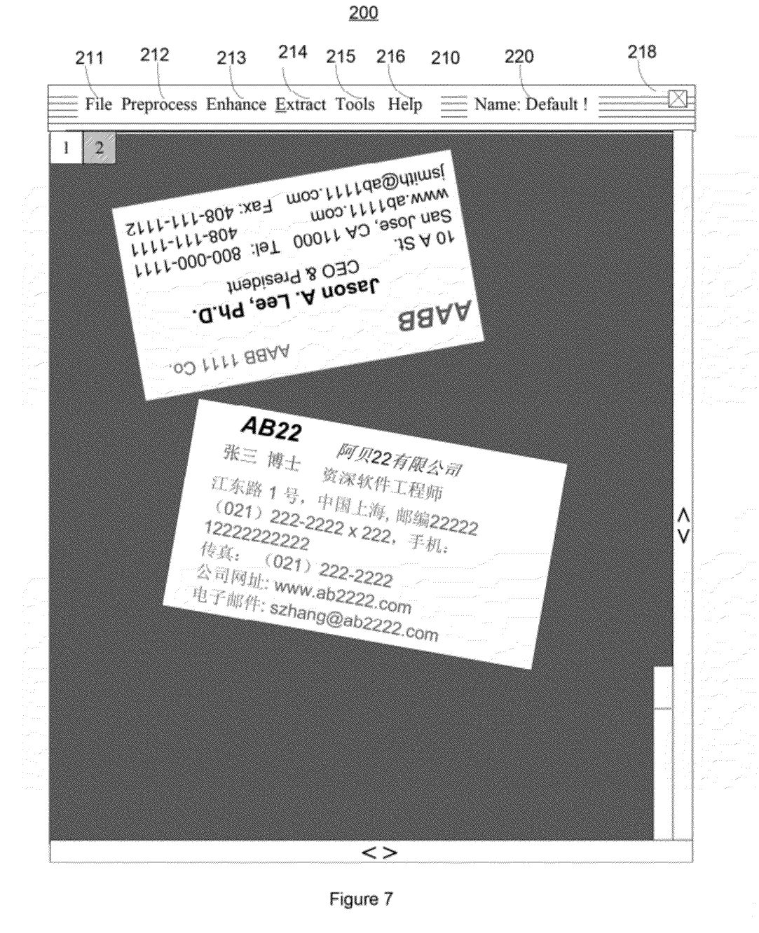

Then the next thing is to automatically detect all the business cards in the image as in step 154, first to find their boundaries. To do so, the user clicks the “Detect Cards” button of the “Preprocess” menu bar item 2121 to instruct the SW to start the job. The SW shall use some image processing algorithms in information extracting module 112 to automatically find the boundary of all business cards on the image. There can be many algorithms for that, and one method is illustrated in dataflow diagram 300 in FIG. 6. The first step 302 in it is to do noise filtering e.g. to use a median filter or a low-pass filter such as a Gaussian filter in spatial domain or a Butterworth filter in frequency domain [2]. Then it checks if the image is a normal image with dark foreground and bright background 303 as in FIG. 4 and FIG. 5, if the image contains bright background, then applies morphological dilation filter several times to it to enhance the foreground 304, otherwise it bypasses the morphological dilation filtering for an image with dark background. Then in step 305, it binarizes (i.e. segments all the pixel grayscale values into two values according to a predetermined threshold or an adaptive threshold based on the image histogram distribution) the whole image with a threshold which can be predetermined or can be obtained based on the histogram of the image, i.e. in an adaptive way. Notice it applies different thresholds, for images with dark background as in FIG. 7 and images with bright background as in FIG. 4 and FIG. 5. Normally the threshold can be somewhere between the background peak and the foreground peak in the histogram curve of the image. Then in the next step 306, it checks again if the image contains dark foreground, if so, it inverts the image grayscale values 307. For example for a grayscale image with 8-bit pixel depth and using unsigned char data type, the inversion is simply I′(x,y)=255−I(x,y), where I(x,y) stands for image grayscale value at pixel (x,y). Then in the next step 308, it projects the image in horizontal/X direction and vertical/Y direction as:

$$P ( x ) = {\sum }_{j} I ( x , y ) , x = 0 , 1 … Nx - 1 \\ P ( y ) = {\sum }_{i} I ( x , y ) , y = 0 , 1 , … Ny - 1 \qquad Equation 1$$

where I(x,y) stands for image grayscale value at pixel (x,y), and totally the image contains Nₓ×N_{y} pixels. Then on each projection, it searches plateaus with certain criteria 310 e.g. starting from the highest count in projection and search in both directions for the plateau down hill, and then back projects the plateau boundaries to the image space 311. When the back projected two boundaries of a plateau in horizontal direction and the back projected two boundaries of a plateau in vertical direction meet, together they define a candidate card area in the image space. For example, if there are two plateaus in vertical projection data (y₁, y₂), and (y₃, y₄), and two plateaus in horizontal projection data (x₁, x₂), (x₃, x₄), they form 4 candidate business card areas in image space, (x₁, y₁), (x₂, y₁), (x₁, y₂), (x₂, y₂) as the first one, (x₁, y₃), (x₂, y₄), (x₁, y₃), (x₂, y₄) as the second one, (x₃, y₁), (x₄, y₁), (x₃, y₂), (x₄, y₂) as the third one, and (x₃, y₃), (x₄, y₄), (x₃, y₃), (x₄, y₄) as the forth one. Here a candidate business card area is determined by its 4 corner pixel locations, which are rounded to integers. Then the next step 312 is to check each candidate card area, one simple way is to see if the total foreground counts can reach a predetermined threshold, if not that candidate card area will be disqualified. This approach does not depend on what languages are used in the cards. Certainly more complicated algorithm can also be used to automatically detect all the cards in the scanned image, but often with the trade off of computing time. One effective approach is to set the scanner 120 to provide scanned image with dark background, that will not only help automatically detecting business card boundaries in the scanned image but also help automatically detecting business card orientation in the image as will be described in later sections.

Automatic card boundary detection may still fail under certain circumstances, so manual card boundary refining can be done right after the automatic card boundary detection, but alternatively it can be done together with manual card orientation refining after automatic card orientation detection and correction have been done, and this is the option chosen in this example.

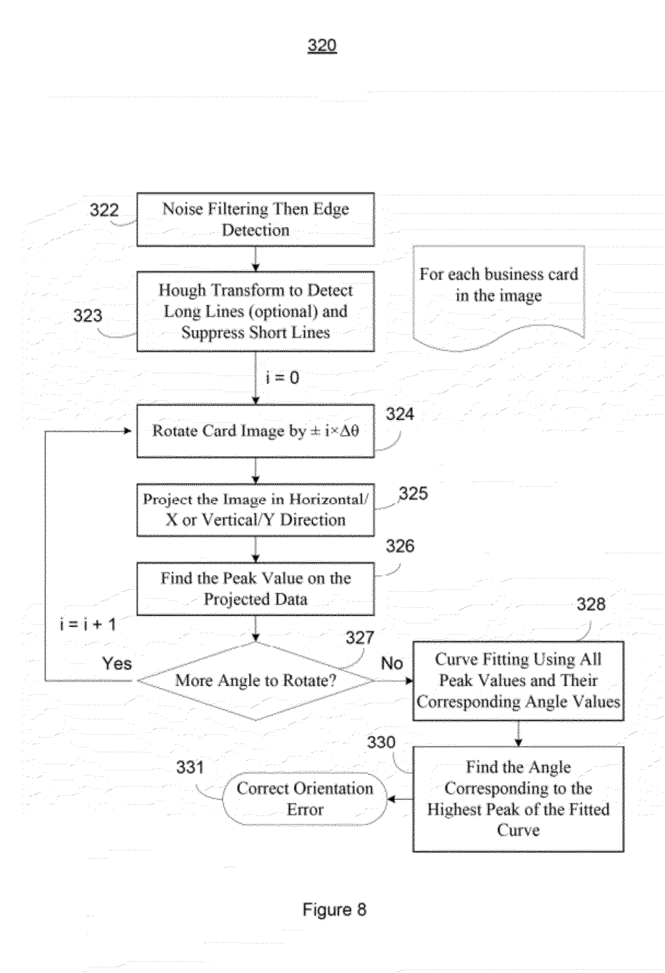

Then the next thing is the automatic detection of the business card orientation in the image, the second part of step 154, one by one for each card in the image. As in dataflow diagram 320 in FIG. 8, typically the first step 322 for orientation detection of one card is to do noise filtering followed by an edge detection e.g. using Sobel edge detection [1, 2] or Canny [2] edge detection algorithms, optionally followed by Hough transform [1, 2] to filter out short lines 323. This Hough transform is optional since it is a time consuming operation, it can help in many cases but is not absolutely necessary. Then it rotates the selected card image in both directions in a sequence of steps, each time by increasing by an amount of Δθ° 324, and then projects the rotated image in either horizontal/X direction or in vertical/Y direction 325 using Equation 1. Then it searches the peak value 326, i.e. the highest value in the projection data at each angle of rotation. With all the peak values at different angles of rotation and all the corresponding angle values 328, it can fit a curve 330 e.g. a quadratic curve as:

f(x)=ax²+bx+c Equation 2

which essentially only needs a minimum of 3 points around the peak. Sometime it can fit a Gaussian curve as:

$$f ( x ) = \frac{1}{\sqrt{2 π } σ} {e}^{- \frac{{x}^{2}}{2 {σ}^{2}}} \qquad Equation 3$$

with center at x=0, and it can be used for more points (angles) over a large range to roughly get to the neighborhood of the best angle first, and then use Equ. 2 for further fine angle finding. Finally it can find the peak value of the fitted curve and its corresponding angle value 330, and then rotate the card according to the angle to make the orientation correction for each card, and that is the end of the dataflow 331.

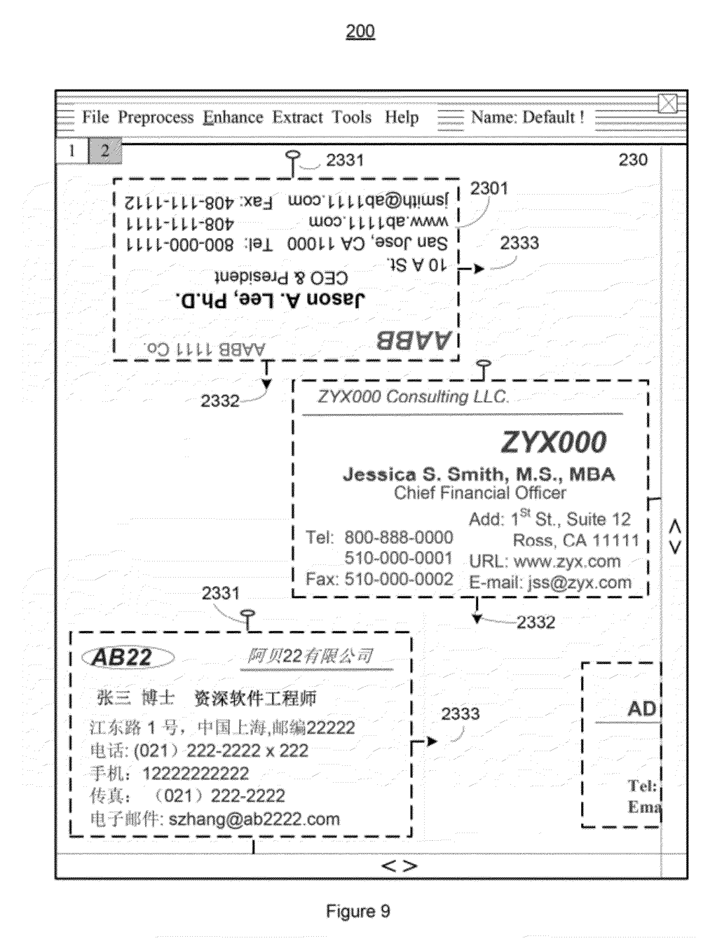

As an example, the boundaries of all the business cards in FIG. 4 are found in this way, and are also highlighted with a bounding box around each business card as shown in FIG. 9. Notice in this example, since some cards' skew angles (the angle between card's boundaries or text rows and the image boundaries, e.g. 2322 on FIG. 5) are way too big, e.g. card 2301 is almost upside-down and card 2030 also has a big skew angle, so their orientations may not be correctly detected automatically by the SW without using more sophisticated algorithms such as using moments which can be very time consuming for a computer's central processing unit (CPU). For instance one way is to use an OCR algorithm to detect certain characters such as “@”, “www”, and “.com”, to determine the whole card orientation. But if the scanned image has a dark background as in FIG. 7, then the success rate of detecting that angle correctly is much higher since cards boundaries provide long and clear lines and can be detected easily by an edge detection algorithm. The business cards in the image with detected skew angles will be rotated to get the skew angle corrected.

Since the automatic card detection may not always yield good results without using sophisticated algorithms while considering computation time in real-world applications, the step of manual card refining 155 in dataflow diagram 150 in FIG. 2 is normally needed after automatic business card boundary detection and automatic business card orientation detection and correction. As can be seen in FIG. 9, each card in the image display area when selected (by computer mouse) has boundaries which can be dragged to change in both horizontal direction 2332 and vertical direction 2333. On top of each card's boundary, there is a nail-like handle 2331 allowing the user (by mouse motion) to rotate the card image. Image rotation here and in above text about automatic card orientation finding, around a rotation center (x_{c}, y_{c}) can be done as:

$$( \begin{matrix}x 2 \\ y 2\end{matrix} ) = ( \begin{matrix}cos θ & - sin θ \\ sin θ & con θ\end{matrix} ) ( \begin{matrix}x 1 - yc \\ y 1 - yc\end{matrix} ) + ( \begin{matrix}xc \\ yc\end{matrix} ) \qquad Equation 4$$

where θ is the rotation angle. The rotation center (x_{c}, y_{c}) is the center of each card's bounding box. For digital image, the above formula yields non-integer pixel positions after rotation and therefore certain interpolation of pixel values is needed. Common interpolation e.g. bilinear interpolation using 4 neighboring pixels [1, 2] or bi-cubic interpolation using 16 neighboring pixels or other interpolations [2] can be used. The rotated card image will still be put in the same scanned image replacing/overwriting the card image there before the rotation, the user can always select a card in the image, drag it to move it around. During rotation, some truncation of the rotated card or some overlapping with neighboring card may occur. However, these actions are recoverable before the user saves the results.

In this step, the user may need to add a card bounding box to the image by using the sub menu “Add a Card” button of “Preprocess” menu bar items 2121, when a card in the image is not detected automatically by the algorithm for some reasons e.g. poor image quality. Also on the other hand, the user can delete a false detected card automatically detected by using the sub menu “Delete a Card” of “Preprocess” menu bar function 2121, then that card's bonding box (over-layer) will disappear from the image. The user can also move a card manually within the image boundary, but need to make sure there is no overlap with other cards in the image. Furthermore, image processing such as brightness and contrast change and noise filtering with pre-defined low-path filters e.g. Gaussian filter or Butterworth filter [1, 2] can be applied to the selected business card image when the user uses “Enhance” menu bar function 2131 as in FIG. 3. Here the image processing will be applied to the selected business card image in the scanned image or to all cards in the image if no single card has been selected. Also in this preprocessing step, when there are contaminations or unwanted things 2320 on a card 2314 (in FIG. 5) which may affect further information detection/extraction, the user can use an eraser provided by sub menu button “Erase” of menu bar item “Enhance” to wipe out the foreground pixels i.e. to set the (foreground) pixels to the background values which can be found by the taking the histogram of that card image [1, 2]. The user shall be able to use the mouse to move the eraser.

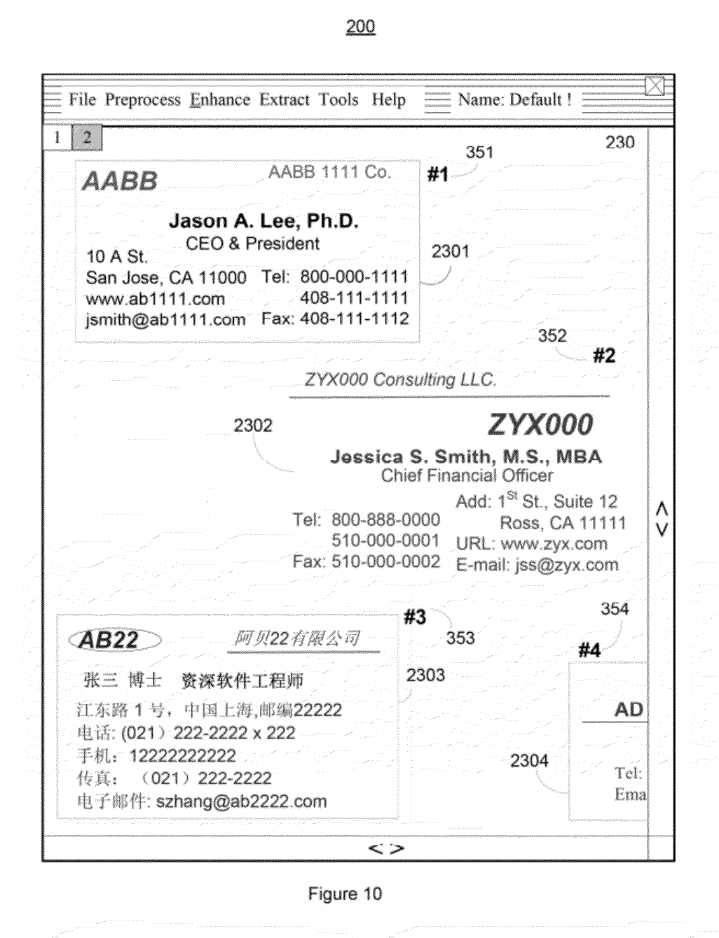

After refining each business card in the image in step 155 in dataflow diagram 150, all the business cards in FIG. 4 and FIG. 9 now look normal in FIG. 10 as an example, and each one business card in one scanned image can be assigned a unique identification (ID), e.g. card 2301 with an ID “#1” 351, card 2302 with an ID “#2” 352, card 2303 with an ID “#3” 353, and card 2304 with an ID “#4” 354.

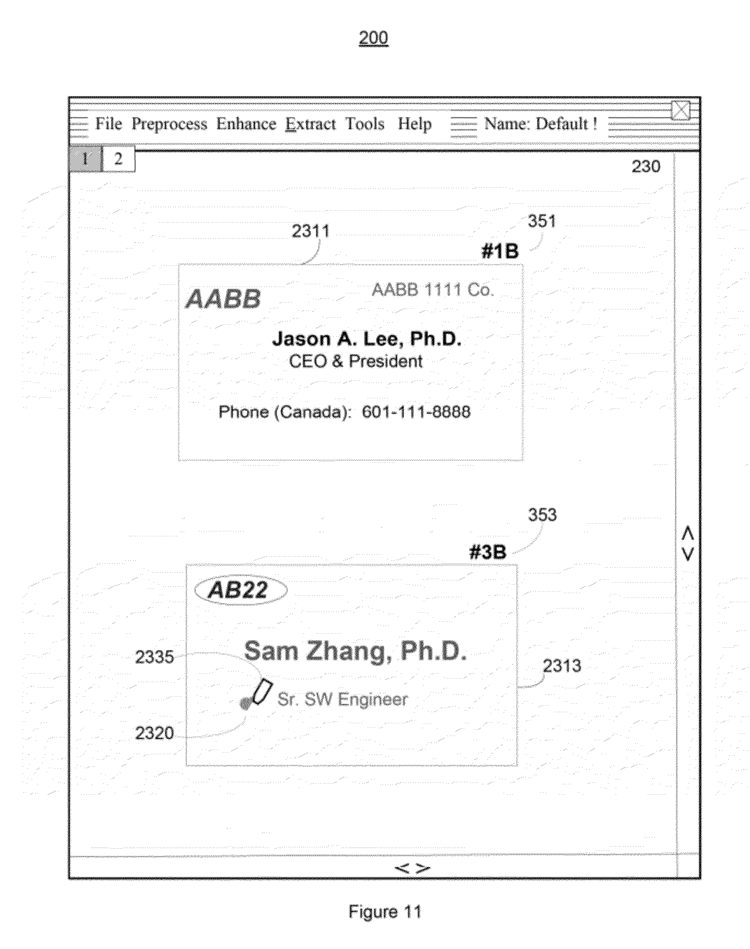

After preprocessing the first image whether it was scanned or loaded from somewhere, the user can scan or load the second image through the sub menu “Scan 2^{nd} Image” or “Load 2^{nd} Image” button of menu bar function “File” 2111 of the image display window 200. That is normally used when the user wants to extract the backside information from some of the business cards in the first image. The second image, as well as all cards in it can go through the similar preprocessing steps as for the first image. As an example, the cards in the second image shown in FIG. 5 are preprocessed and the preprocessing results are shown in FIG. 11 for illustration purpose. Notice the image display is switched to the second panel “2” 222 to display the second image. The cards on the second image also have ID's. As a convenient convention, if the ID of a card in the first image matches the one in the second image, then the two cards are related as front side and backside of single business card. The one with an ID which has an appendix, for example a character “B” or “S” indicating that card image is the backside image of the business card. Normally the one in the second will bear that appendix by default, but the user can change that. With the same example, the ID of card 2311 is “#1B” 351 (FIG. 11) indicating it is the backside of card “#1” in the first image (FIG. 10), and the ID of card 2313 is “#3B” 353 (FIG. 10) indicating it is the backside of card “#3” in the first image (FIG. 10). Later on the information extracted from the backside of a business card will be reconsolidated with the information extracted from the front side of that business card.

Then the next step as illustrated in the dataflow diagram 150 is to automatically detect key information areas/zones as step 156, more specifically to detect the boundaries of all selected/configured key information areas in each business card image. Key information includes prefix such as Mr. Ms. Miss. Dr. etc., name including first name, middle name or middle name initial, last name, suffix such as M.B.A, Ph.D. etc., job title such as SW Engineer, Consultant, VP, CEO etc., phone number, mobile phone number, fax number, e-mail address, affiliation, address, and web address/Universal Resource Locator (URL). Sometime people may have multiple phone numbers on their business cards, and therefore there can be two phone numbers. The SW allows the user to configure/select (functions of menu bar “Tools”) which key information items will be used.

There is no simple but effective method to detect all the information areas, especially when many languages other than English are allowed. However, some key information areas may still be automatically detected with certain “a prior” knowledge. For example, a phone number area shall only contain numbers from “0” to “9” possibly with dash sign “-” in between or with parenthesis “(” and “)” in it, a mobile phone number in some country contains 11 digits and always starts from 1, an e-mail address shall always contain “@” and most likely ends with “.com”, “.edu”, and “.org” etc., a Internet web address/URL always starts with “www” etc. Some OCR algorithms e.g. the Hu's 7 moment invariants are independent from character scaling and rotation, and can be used to detect them.

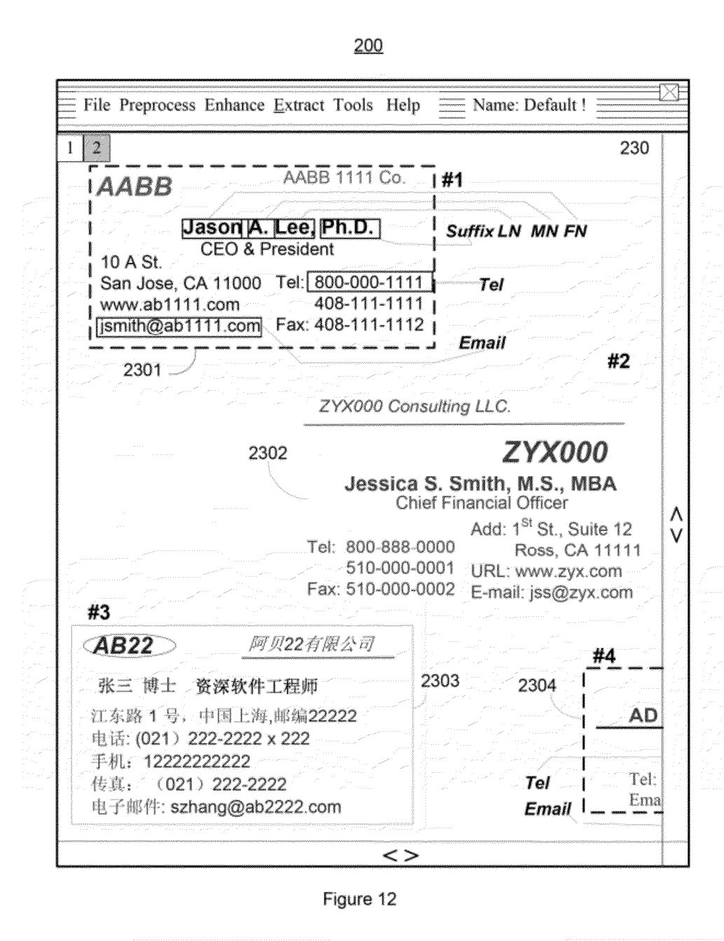

To let the SW automatically detect key information area of selected cards for all cards in the image, the user can go to sub menu function “Detect Key Area” under menu bar item “Preprocess” 2121 in FIG. 3. For example as shown in FIG. 12, card #1 2301 and #4 2304 are selected and their key information areas are all displayed as over-layer drawings (rectangle, text, and a line in between connecting them) on their card image. Notice for the case of card #4 2304, foreign languages are allowed, as long as the OCR engine supports that language. To make things simple, the SW can be further customized for users in different countries by providing two languages, English plus a secondary language which is normally the local language of the user.

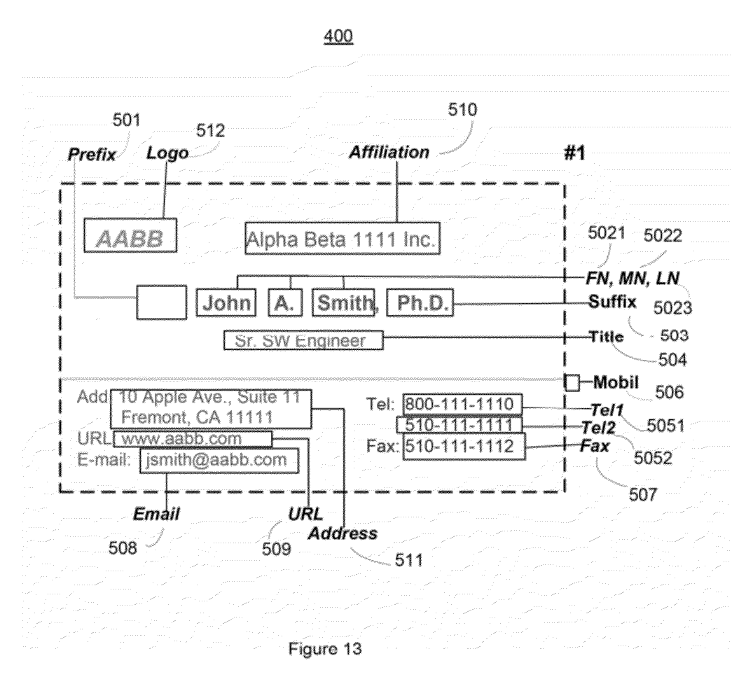

Again, automatic key information area detection may not be successful all the time due to the complicity, therefore a key feature of the invention is to provide templates for all key information areas to the user as over-layer drawings on each business card image. The SW provides a rectangular bounding box for each information area with corresponding name and a connection line between them. For example in FIG. 13 for a business card in image display area 230, almost all the possible key information areas are shown to the user, they are prefix 501, first name 5021, middle name or middle name initial 5022, last name 5023, suffix 503, title 504, telephone number 1 5051, telephone number 2 5052, mobile phone number 506, fax number 507, e-mail address 508, web address 509, affiliation 510, address 511, even image of the logo 512 (though that is normally not needed). Normally, not all the key information areas are needed, so the main SW implementing this invention allows the user to select needed key information areas instead of using all of them through a configuration process. In this exemplary embodiment, the user can use sub menu functions of “Tools” 215 menu bar item (not shown) to configure the SW to only display templates of selected/configured key information areas. In step 157 of the dataflow diagram 150, it shall allow the user to manually adjust the key information areas, i.e. the boundaries and locations of the key information areas as shown in FIG. 12 and FIG. 13 simply by computer mouse dragging. Some information areas may be missing and some information areas may be mistakenly detected by the automatic key information area detection algorithm in the SW, so at this step the user can go to sub menu functions “Disable a Key Area” and/or “Enable a Key Area” of menu bar item “Preprocess” 2121 to disable or enable a key information area. When a key information area is disabled, it contains no characters i.e. null in it. Again not all the above information areas shall appear on certain business card, some key information area can be missing and some can contain foreign languages. Also, if a key information item has not been selected, it will not show up on the image at all. After this manual process of refining key information areas, as step 157 in dataflow diagram 150, each business card shall have correct key information areas (as rectangular over-layers with texts and connecting lines) positioned for key information areas in the selected cards, like the one in FIG. 12 and FIG. 13.

Then it goes to the next step 160 in the dataflow diagram 150. By now if the user wants to scan/load and process the backside of some business cards in the second image and has not done so, it is the time now, and the dataflow can go back to step 151, and go through the same steps as for the first image. However, the action of loading the second image does not have to happen here, the user can load the second image anytime after loading the first one, since the two images can both be loaded to the SW and displayed one under panel “1” 221 and one under panel ‘2” 222.

All the above preprocessing tasks in dataflow diagram 150, whether for card detection including boundary and orientation, automatic or manual, or for key information area detection, automatic or manual, are started from the GUI 200 of the main SW running on the host computer 110, and dispatched to the preprocessing module 111 to get the jobs done. For some tasks, the preprocessing module 111 may use IP engine 115. Now it proceeds to the next step 161. When the information areas have been determined for selected cards in the image(s), the user can click the menu bar button “Extract” 214 to instruct the SW to extract information from all key information areas. Internally the SW on the host computer 110 calls the information extracting module 112 to do the job, and the information extracting module may use OCR engine 114 and IP engine 115. As explained in earlier sections, not all key information areas are needed, and the user can configure on what key information to be used.

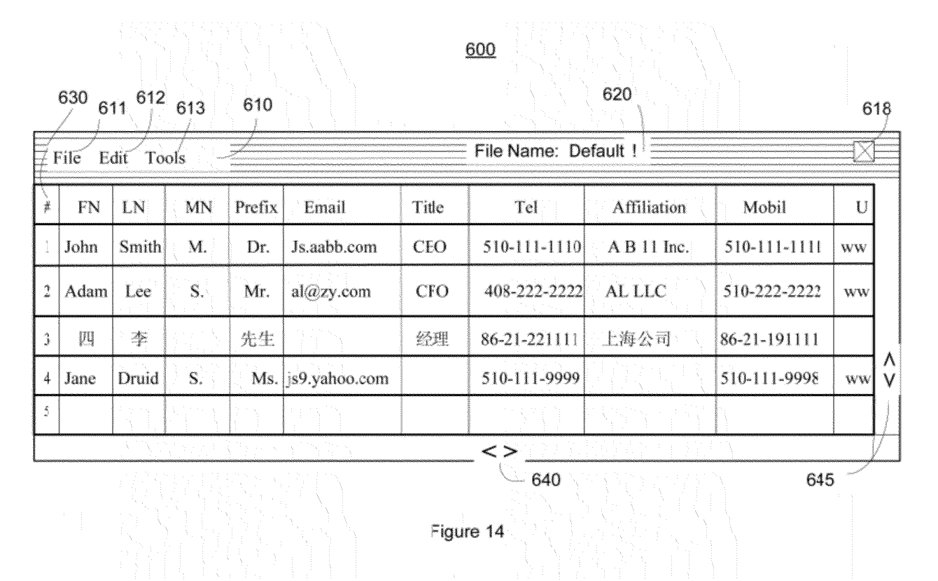

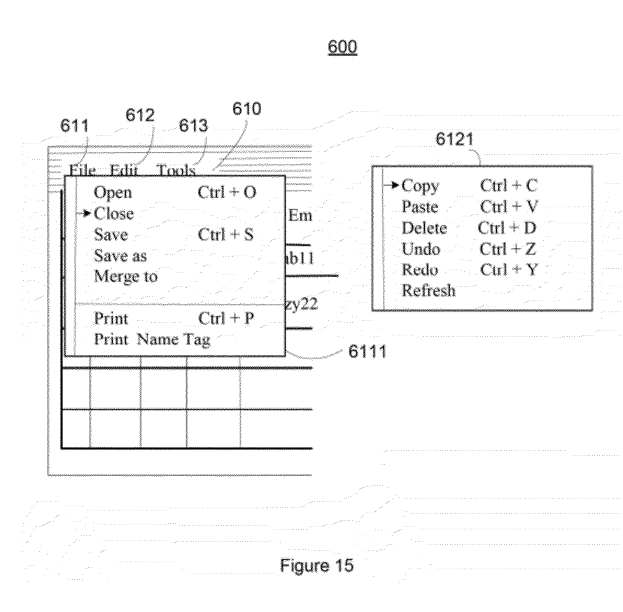

Then the next step on the dataflow diagram 150 is to extract key information on selected cards which includes prefixes, names (first names, middle names or initials, last names), suffix, address, phone number, mobile phone number, fax number, e-mail address, URL/web address, title, affiliation etc. The user can invoke the task by clicking menu bar button “Extract” 214 (FIG. 3). When that happens, the main SW automatically creates a temporary table 600 as shown in FIG. 14, and FIG. 15, or if there is an existing temporary table 600, it may flushes the table with a popup window to ask for the user's confirmation (not shown).

The key information extraction is done by the information extracting module 112 which uses OCR engine 114 and IP engine 115. At this step, all selected key information items of all selected cards will be extracted. Each card's image (not the whole scanned image which contains one or more cards in it) may be processed by conventional image processing algorithms before going through OCR process to detect characters in each key information area. There are a few different OCR algorithms for different OCR applications. For this application, region-based algorithm such as Hu's 7 moment invariants [3] can be used. In Hu's moment invariants approach, it starts with preprocessing the image e.g. noise filtering and binarization to get binarized image (all pixels are in two grayscale values). Then a sub image containing and only containing a testing character e.g. is taken from a business card image. The regular moments of that sub image are:

$${m}_{pq} = {\sum }_{x} {\sum }_{y} {x}^{p} {y}^{q} I ( x , y ) , p , q = 0 , 1 , 2 … \qquad Equation 5$$

where I(x,y) is the grayscale value of the image at pixel (x,y). Then the central moments are:

$${μ}_{pq} = {\sum }_{x} {\sum }_{y} {( x - {x}_{c} )}^{p} {( y - {y}_{c} )}^{q} I ( x , y ) , \\ p , q = 0 , 1 , 2 … \qquad Equation 6$$

where x_{c}=m₁₀/m₀₀ and y_{c}=m₀₁/m₀₀. Then the normalized central moments are:

$${η}_{pq} = \frac{{μ}_{pq}}{{μ}_{pq}^{γ}} , γ = ( p + q + 2 ) / 2 , p + q = 2 , 3 , … \qquad Equation 7$$

Then Hu's seven moment invariants φ₁ through φ₇ are:

φ₁=η₂₀+η₀₂

φ₂=(η₂₀−η₀₂)²+4η₁₁²

φ₃=(η₃₀−3η₁₂)²+(3η₂₁−η₀₃)²

φ₄=(η₃₀+η₁₂)²+(η₂₁+η₀₃)²

φ₅=(η₃₀−3η₁₂)(η₃₀+η₁₂)[(η₃₀+η₁₂)²+3(η₂₁+η₀₃)²]+(3η₂₁−η₀₃)(η₂₁+η₀₃)[(3η₃₀+η₁₂)²−(η₂₁+η₀₃)²]

φ₆=(η₂₀η₀₂)[(η₃₀+η₁₂)²−(η₂₁+η₀₃)²]+4η₁₁²(η₃₀+η₁₂)²−(η₂₁+η₀₃)²

φ₇=(η₂₀η₀₂)[(η₃₀+η₁₂)²−(η₂₁+η₀₃)²]+4η₁₁²(η₃₀+η₁₂)²(η₂₁+η₀₃)² Equation 8

For instance in case of OCR for English language, Hu's moment invariants of the 26 characters and some symbols are pre-calculated, then the Hu's moment invariants of a testing character can be compared with them one by one. The comparison can be done by considering Hu's moment invariants as a 7-dimensional vector and computing the Euclidean distance between the vector of a template character and that of a testing character. Sometime for better throughput, only first 4 of the Hu's 7 moment invariants are used [4]. There are also other moments such as Zernike moments which also have invariance properties to image translation, rotation, and scaling [4]. There are other OCR algorithms which are not moment-based, one type is shape-based, e.g. the Fourier descriptor algorithm and chain code algorithm [2, 5, 6] which normally required thinning process first on the binarized image.

When the key information extraction is done, the SW running on the host computer 110 sends the result to the information organizing module 113, which optionally may use a commercial database system 116.

In the table 600, the information of each business card occupies one row, and the key information items make the columns, which are prefixes, names (first names, middle names or initials, last names), suffix, address, phone number, mobile phone number, fax number, e-mail address, URL/web address, title, affiliation etc. Again, the table 600 does not have to show all the key information items in it columns 630 but only those selected during configuration. The table 600 may also contain an “Image” column which may contain the full name of the card image (cut from the scanned image) on the data storage media of the computer 110. Behind the scene, a compressed card image e.g. in JPEG 2000 format can be stored and the IP engine can contain a JPEG 2000 encoding/decoding module.

The table 600 includes a menu bar control 610 which contains menu bar items as “File” 611, “Edit”612, and “Tools” 613 as shown in FIG. 15. It also includes a name area, which will show “Default” when the name of the table has not been given by the user and will show a mark such as the exclamation sign “!” after the name when the content of the table has been changed and not yet been saved to a storage media such as hard disk of the host computer 110. It also contains a window closing button 618, a horizontal scroll bar 640, and a vertical scroll bar 645 since often all the columns and rows cannot fit into one window on the computer's display monitor.

Since the OCR algorithm may not work perfectly for all business cards, especially when the some card images are not in good condition or there are foreign languages that the OCR engine does not support, user's manual editing of the table may be needed as in step 162 in the dataflow diagram 150. During manual editing, the user can modify (adding, deleting, copying and pasting etc) any card information in all rows of the table 600. Menu bar item “File” 611 further contains sub menu items 6111 as “Open” button for opening an existing business card result file for editing (in a separate table, and at mean time the image display window 200 will be flushed in order to synchronize the change in the table), “Close” button for closing the current table without saving it and at mean time the image display window 200 will be flushed also to synchronize the change, “Save” button for saving the current table to a storage media of the computer 110 and a default name will be suggested when there is no name given to the current table, “Save as” button for saving the current table in a different name, “Merge to” button for merging the current table to an existing table whether it is in the storage media of the computer as a file or is a currently opened one, and the merged result shall contain information of both tables in one in a sorted way e.g. by last name alphabetically, “Print” button for printing out on a networked printer the selected table contents or all table contents, and “Print Name Tag” for printing names and titles only in extra large font for conference/banquet badge. There can be other ways to fully or partially export the table contents, e.g. to export name, phone number, and mobile phone number to a wireless receiver through wireless protocols such as ZigBee or WiFi. Menu bar item “Edit” 612 further contains sub menu items 6121 as “Copy” button for copying selected table contents, “Delete” button for deleting selected table contents in certain rows, “Paste” button for pasting contents selected by “Copy” function, “Undo” button for undoing the last editing action, “Redo” button for recovering the editing action cancelled by the last “Undo” action, and “Refresh” button for refreshing the table which always provides a pops up window (not shown) for the user to confirm the action first. Menu bar item “Tools” 613 contains functions for the user to configure the table, e.g. to show/hide or gray out some of the empty or uninterested columns. Some of the sub menu functions may have computer keyboard shortcuts e.g. “Ctrl+C” stands for “Ctrl” key and “C” key combination for “Copy” function. It also supports many common keyboard functions e.g. “Insert”, “Delete” (not shown) as well.

The logic and the internal data for the data management over the table 600 are part of the information organizing module 113. Since many foreign languages are supported by the OCR engine and table 600, so behind the scene, the characters are encoded by Unicode as opposed to ASCII code.

As can be seen on the dataflow diagram 150, when manual editing of the table contents is done, the user can move to the next step 163 as an option if the user wants to merge the table with another table as in step 164. The current table can be merged with an unopened table in the data storage media of the computer 110 e.g. its hard disk as a file, or to a currently opened table. If contents in two tables are merged, the rows will be reorganized according to the sorting priority of columns/key information items, e.g. by default they can be sorted by last name alphabetically, then first name and so on.

Then in the dataflow diagram 150 as the next step 165, the user can choose to save the table as in step 166 to the data storage media of the computer 110, possibly by using a commercial database system 116 such as My SQL™ or Microsoft Office Access™, or simply by using a computer file system and the table can be converted to Microsoft Office Excel™ format (spreadsheet format) or in the Extensible Makeup Language (XML) format. Below is an example of using XML data format without getting too deeper into its data presentation style and data type constraints, e.g. for the data in row #1 and #2 of table 600 in FIG. 14 is putting the key information items as XML tags as:

...
<card >

<prefix> Dr. </prefix>
<name>

<fn>John</fn>
<mn>M.</mn>
<ln>Smith</ln>

</name>
<email>Js.ab11.com</email>
<title>President</title>
<tel> 510-111-1110</tel>
<mobile>510-111-1111</mobile>
</fax>
<affiliation>AB 11 Inc.</affiliation >
<url>www.ab11.com</url>
</address>

</card>
<card >

<prefix>Mr. </prefix>
<name>

<fn>Adam</fn>
<mn>S.</mn>
<ln>Lee</ln>

</name>
<email>alzy22.com</email>
<title>CFO</title>
<tel>408-222-2222</tel>
<mobil>510-222-2222</mobil>
</fax>
<affiliation>AL LLC</affiliation >
<url> www.alllc.com </url>
</address>

</card>
...

where according to XML grammar, <name> marks the beginning of an XML tag “name” and </name> marks the end of it with the value/content in between. An unpaired tag e.g. </address> stands for an empty tag, in this case, the null/empty key information item.

Thus up to now, a complete application lifecycle of the business card reading and managing system ends at step 168.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCES

[1]. Gonzalez R C et al, Digital Image Processing, 1992, Addison-Wesley Publishing Company Inc. USA
[2]. Pratt W K, Digital Image Processing, Second Edition, 1991, John Wiley& Sons, Inc., USA
[3]. Chen C C, Improved moment invariants for shape discrimination, Pattern. Recognition, 1993, pp 683-686, Vol. 26 (No. 5).
[4]. Flusser J et al., Affine Moment Invariants: A New Tool for Character Recognition, Pattern Recognition Letters, 1994, pp 433-436,Vol. 15
[5]. Trier Ø D et al., Feature extraction methods for character recognition-A survey, Pattern Recognition, 1996, pp 641-662, Vol. 29 (No. 4).
[6]. Chen Q, et al., Optical Character Recognition for Model-based Object Recognition Applications, Proceedings. The Second IEEE International Workshop on Haptic, Audio and Visual Environments and Their Applications, 2003, pp 77-82

What is claimed is:

1. A system for business card information reading and managing, comprising:
a host computer with data storage media and input/output (I/O) devices;
a preprocessing module coupled with the host computer;
an information extraction module coupled with the host computer;
an information organizing module coupled with the host computer;
an optical character recognition (OCR) engine coupled with the host computer; and
an image-processing (IP) engine coupled with the host computer.

2. The system according to claim 1, wherein the image-processing engine comprises a database system.

3. The system according to claim 1, further comprising a scanner module coupled with the host computer, adapted for scanning one or more business cards into an image with a dark background.

4. The system according to claim 3, wherein the preprocessing module, the information extracting module, the information organization module, and the scanner module are implemented in a pure hardware (HW), a firmware on HW including digital signal processor (DSP) and FPGA, or in a pure software (SW) without any limitation to computer operating system (OS) and programming language.

5. A method for business card information reading and managing, comprising the steps of:
scanning or loading an image containing one or more business cards, and if the image is a color image, converting the color image into a grayscale image;
automatically preprocessing all the cards in the scanned image(s) to detect each card's boundary, location, and orientation and also correct its orientation by rotating the card sub image in the scanned image, using certain algorithms;
manually preprocessing all the cards in the scanned image(s) to refine their boundaries, locations, and orientations, and also correct their orientations;
automatically detecting each business card's key information area including their bounding boxes and extract key information including prefix, name, suffix, email address, phone number, mobile phone number, fax number, affiliation etc. using certain algorithms;
manually refining each business card's key information area with the help all the key information area templates provided by graphic user interface (GUI);
for each key information area on each card, extracting the information using OCR algorithms supported by image processing algorithms to detect characters in all supported languages;
loading the extracted key information to a temporary table for all cards in the image(s) allowing a user to further editing the table; and
allowing the user to merge the table with an existing table, and save the table in different ways such as in a database system or in a file system of the host computer using text or XML format.

6. The method according to claim 5, further comprising the step of scanning or loading the second image containing one or more business cards, normally the backsides of the cards in the first image.

7. The method according to claim 5, wherein the name comprises at least one of a first name, a middle name, an initial name and a last name.

8. The method according to claim 5, being corresponding to a software dataflow logic.

9. The method according to claim 5, being supported via a main SW running on the host computer with its GUI for the user to go through all the steps interactively with the software of the system.

10. The method according to claim 5, wherein the automatically card boundary detection is performed by the steps of:
noise filtering the whole scanned image, not each card's sub image with certain various low-pass filter or median filter;
checking if the image has dark background or not, if so does morphological dilation for a predefined number of times;
binarizing (segmenting pixel grayscale) the whole image using a predetermined threshold or an adaptive threshold based on the image histogram;
checking if the image has dark background or not again, if so, inverting the image foreground with its background;
projecting the image in both horizontal (X) direction and vertical (Y) direction;
searching for all plateaus in the projections;
back projecting all plateau boundaries into image space, to find candidate business card areas in the image; and
further checking/qualifying candidate business card areas in the image, preferably, using the total counts (some of the foreground pixels) in each candidate business card areas in the image.

11. The method according to claim 5, wherein the automatic card orientation and correction are performed by the steps of:
noise filtering e.g. using median filter and/or low-pass filter followed by edge detection e.g. using Sobel filter;
optionally applying Hough transform, then filtering out the short lines and keeping the longer lines;
rotating the image in both directions each time with an increment of i×Δθ with i=0, 1, 2, . . . ;
for each angle of rotation, i.e. each i, projecting the image in horizontal (X) or vertical (Y) direction;
at each angle of rotation, finding the peak value on the projection data;
after going through all the rotation angles, using all the peak values of each projection to fit a curve, e.g. a parabolic curve, the fitted curve peak location corresponds to the skew angle/orientation of that business card in the image.

12. The method according to claim 5, further comprising providing the user a complete set of templates for key information such as prefix, first name, middle name or initial, last name, suffix, email address, phone numbers, mobile phone number, fax number, affiliation, address, web address etc. for the user to modify them manually i.e. to enable/disable/move/resize each of them, wherein each template appears on a card in the image as over-layer drawings including a rectangle, its name as a text string, and a line connecting the rectangle and the name.

13. The method according to claim 12, further allowing the user to configure/select key information items to appear/hide on the cards in the scanned image.

14. The method according to claim 5, further comprising a table to hold the extracted key information from all cards in the image or the image pair, with its columns for key information items and rows for business cards, wherein the table can be edited i.e. it supports adding, deleting, copying, pasting, undo, redo etc., and can be merged to another table whether the table is a saved table in file or an opened one, to be saved/persisted using database system or simply computer file system in various format such as XML.

15. The method according to claim 5, further comprising mechanism of scanning and reading both sides of one or more business cards, e.g. by automatically assigning an unique ID for each card in the pair of images, further allowing the user to modify the ID's, and having an appendix letter/symbol to mark the back side card.

16. The method according to claim 5, further comprising allowing image processing e.g. noise filtering in various ways and histogram manipulations on each card image within the scanned image but not to the whole image, i.e. each card's sub image in the scanned image can be processed differently and be written back to the scanned image which can be saved at any time.

17. The method according to claim 5, further comprising an “eraser” control on the GUI and allowing the user to use it to wipe out unwanted pixels on the image i.e. to change the foreground pixel values into background pixel value wherein the eraser can be driven by the computer mouse.
